(19) United States
(12) Patent Application Publication
(10) Pub. No.: US 2004/0122680 A1
(43) Pub. Date: Jun. 24, 2004

(54) Method and apparatus for providing coder independent packet replacement

(76) Inventors: James William McGowan, Whitehouse Station, NJ (US); Daniel A. Quinlan, Warren, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/322,331

(22) Filed: Dec. 18, 2002

(51) Int. Cl. G10L 21/00

(52) U.S. Cl. 704/501

(57) ABSTRACT

A method and apparatus for providing coder independent packet replacement in the presence of frame erasures without requiring that modifications be made to either the encoder or the decoder. An input buffer management process identifies the presence of lost or missing packets and informs a playout buffer management process therof. Then, when packets have been lost, the playout buffer management process advantageously synthesizes an actual signal segment in the absence of a corresponding decoded packet.

### FIELD OF THE INVENTION

The present invention relates generally to the field of packet-based communication systems for coded multimedia (e.g., speech, audio and/or video) signals, and more particularly to the functioning of such communication systems in the presence of lost or delayed packets.

### BACKGROUND OF THE INVENTION

When multimedia signals (e.g., speech, audio and video signals—note that the term “media signal” will be used herein to refer to a signal representing any one or more of these types of signals) are carried in packet-based communication systems, they are usually coded into a digital bit stream within the user's equipment (e.g., Personal Computer {PC}), or within systems lying near the edge of the network (e.g., an Internet Protocol {IP} gateway). In most systems, this step includes some form of signal compression (typically effectuated by an encoder) and a corresponding decompression (typically effectuated by a decoder). At the far end (i.e., at the decoder), however, the equipment must be capable of contending with packets that do not arrive at the destination, or those that arrive too late to be useful.

Lost signal segments can cause severe degradation in quality, and so methods for reducing the problem are an integral part of design for media-bearing products. For example, every voice-bearing product made for use in service provider networks is expected to handle this situation well. Otherwise, the network will not achieve toll-quality voice, and even reasonable intelligibility can be compromised.

There are a variety of ways that such lost (or delayed) packets can be handled. The common approach typically used (especially within the standards community) is to modify the decoder itself to handle the problem of packet loss—typically by imbedding a mechanism for lost packet replacement directly within the decoder. See, for example, the International Telecommunications Union (ITU) “G.711 PLC” standard, which is fully familiar to those skilled in the art. (The added “PLC” stands for Packet Loss Concealment.) Such an approach is described in detail, for example, in U.S. Pat. No. 5,615,298 “Excitation Signal Synthesis During Frame Erasure Or Packet Loss,” issued to J. Chen on Mar. 25, 1997, and commonly assigned to the assignee of the present invention. (U.S. Pat. No. 5,615,298 is hereby incorporated by reference as if fully set forth herein.) However, approaches such as these typically increase the complexity of the algorithm, and thereby lower the overall throughput of the communication system.

One alternative approach to this problem is to detect corrupted or lost packets prior to the decoder, and then to synthesize replacement packets which are fed to the decoder for processing. For example, this can be done with use of a “decoder preprocessor.” Such an approach is described in detail in U.S. Pat. No. 5,550,543, “Frame Erasure Or Packet Loss Compensation Method,” issued to J. Chen et al. on Aug. 27, 1996, and commonly assigned to the assignee of the present invention. (U.S. Pat. No. 5,550,543 is hereby incorporated by reference as if fully set forth herein.) However, although this approach avoids the need to actually modify the decoder itself in order to handle packet loss, it nonetheless (like the approaches in which the decoder itself is modified) still requires additional processing to be performed by the decoder and thus may again lower the overall throughput of the communication system. Moreover, such an approach may not work as well as modifying the decoder in the presence of bursty loss characteristics (i.e., when the loss of several consecutive packets is typical), characteristics that are quite common in many packet-based networks.

### SUMMARY OF THE INVENTION

The present invention improves the performance of coding systems in the presence of lost packets without requiring that modifications be made to either the encoder or the decoder, and also without requiring the decoder to operate on synthesized packet information. Specifically, in accordance with the principles of the present invention, an input buffer management process identifies the presence of lost or missing packets and informs a playout buffer management process thereof. Then, when packets have been lost, the playout buffer management process advantageously synthesizes an actual signal segment in the absence of a corresponding decoded packet.

This coder independent packet replacement method advantageously achieves a similar or better quality to that of approaches which modify the decoder, and, moreover, advantageously does so while providing a substantial improvement in computational complexity. In addition, the approach of the present invention is applicable to any packet-based system (e.g., voice over IP, ATM, frame relay, etc.) in which coded packets are sent through any type of packet-based communications network (e.g., a wireless network, the Internet, etc.).

### BRIEF DESCRIPTION OF THE DRAWINGS

FIG. 1 shows a block diagram of an illustrative packet stream processing method in accordance with one illustrative embodiment of the present invention.

FIG. 2 shows a flow chart of an illustrative input buffer management process in accordance with the illustrative embodiment of FIG. 1.

FIG. 3 shows a flow chart of an illustrative playout buffer management process in accordance with the illustrative embodiment of FIG. 1.

### DETAILED DESCRIPTION

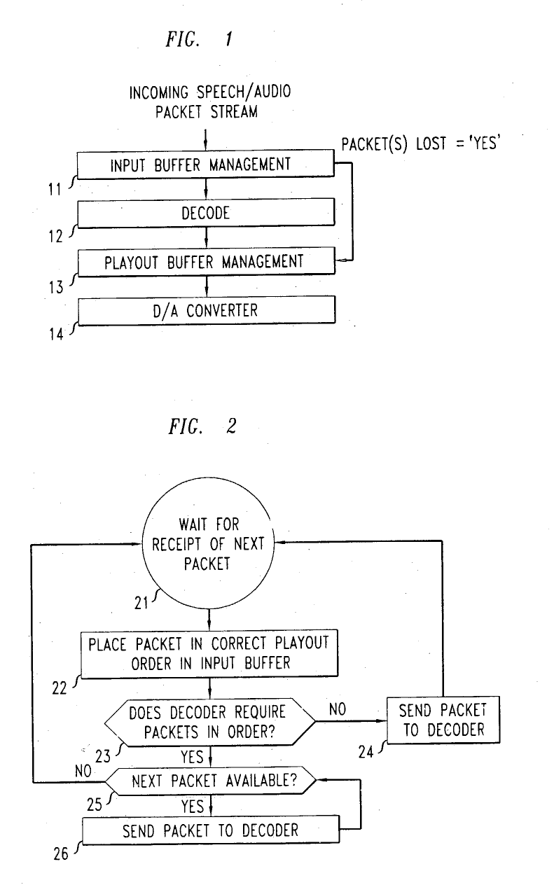

FIG. 1 shows a block diagram of an illustrative packet stream processing method in accordance with one illustrative embodiment of the present invention. Specifically, the illustrative method operates as follows.

When packets comprising one or more frames of an encoded media signal enter the illustrative input buffer management block (block 11) of the figure, a first portion of the process examines the packet headers, strips off the payloads and then ensures that the payloads are sent to the decoder (block 12) in the proper sequential order. (Note that a “frame” is a portion of the signal, typically representative of the signal over a predetermined, fixed amount of time.) In examining the headers, the input buffer algorithm also advantageously detects whether one or more packets have been lost. For example, conventional timeout techniques may be used to determine that a given packet is lost (or unacceptably delayed, which will result in the packet being treated as lost). This information regarding lost packets (i.e., an indication that one or more particular packets have been lost) is then advantageously sent to the playout buffer block (block 13) in accordance with the principles of the present invention.

The playout buffer, managed by the playout buffer management process (block 13), is illustratively a region of memory that receives an ordered series of decoded frames, each decoded frame containing a digital representation of a decoded signal segment, from the decoder (block 12). (Note that, as is well known to those of ordinary skill in the art, each packet typically contains one or more encoded “frames”—each frame representative of one signal segment of a specific time duration. That is, it is usually convenient to group a plurality of coded frames of the original signal together into a single packet for transmission through the communications network.)

Each frame of the reconstructed media signal is then passed in succession to the D/A converter (block 14), which then sends an analog signal into the final analog playback circuitry/transducer(s) in the terminal device. (Note that the terminal device and its playback circuitry are not explicitly shown in the figure.) If a packet has been lost (as identified by the input buffer management process of block 11), any of a number of illustrative mechanisms may be advantageously employed by the playout buffer management process of block 12 to synthesize (i.e., replace) the missing decoded frames.

For example, one illustrative mechanism which may be used to replace the lost portion of the signal is to merely replay previous frames from the playout buffer. The number of such replays needed in each case may be advantageously determined from the packet loss information received from the input buffer management process (block 11). For certain classes of media signals (e.g., speech or audio), whenever multiple replayed frames are played out, it may also be advantageous to adjust downward the magnitude of the signal segment in the frame (i.e., to attenuate the “gain”).

In addition, it may be advantageous in certain circumstances to employ one of a number of various techniques for “smoothing” the boundaries between replacement frames and decoded frames (i.e., those decoded frames which either precede or follow replaced frames), such as those described in detail in co-pending U.S. patent application Ser. No. 09/347,462, “Lost-Packet Replacement For A Digital Voice Signal,” filed on Jul. 6, 1999 by J. McGowan and commonly assigned to the assignee of the present invention, and in co-pending U.S. patent application Ser. No. 09/526,690, “Algorithmic Enhancements For Lost-Packet Replacement In Voice Applications Over Packet-Based Networks,” filed on Mar. 15, 2000 by J. McGowan and also commonly assigned to the assignee of the present invention. (U.S. patent application Ser. No. 09/347,462 and U.S. patent application Ser. No. 09/526,690 are each hereby incorporated by reference as if fully set forth herein.).

In accordance with certain illustrative embodiments of the present invention, various alternate techniques may be employed, or previous frames may be replayed with certain enhancements further employed therewith. In particular, a number of useful packet replacement techniques are described in detail in U.S. patent application Ser. No. 09/347,462 and U.S. patent application Ser. No. 09/526,690. Many of the packet replacement techniques described therein may be advantageously employed by the illustrative playout buffer management process of block 12 to synthesize (i.e., replace) the missing frames.

Therefore, in accordance with one illustrative embodiment of the present invention, the illustrative packet stream processing method may, for example, operate as follows. If no packets are lost, the illustrative input buffer management process (block 11) indicates this by leaving a predetermined code variable set to the value zero. If a packet is lost, the variable is instead set to the value one. In response to this change, the playout buffer management process (block 13) advantageously responds by generating (i.e., synthesizing) replacement material—illustratively based upon the prior material already decoded and sent to the playout buffer by the decoder (block 12). For example, “packet repetition” is one illustrative scheme wherein the previously decoded frame is repeated, either precisely or with certain advantageous adjustments, into the D/A converter (block 14). The number of frames replayed advantageously depends upon the size of the packet payload (i.e., the number of frames in the packet) and upon the number of packets lost.

In accordance with one illustrative embodiment of the present invention, the playout buffer management process may advantageously effectuate packet repetition by simply moving a pointer into the buffer memory to the appropriate location. (As pointed out above, when multiple repeated frames must be played out, it is also advantageous to adjust the magnitude of the signal segment in the frame.) As such, this illustrative approach requires very little computational overhead.

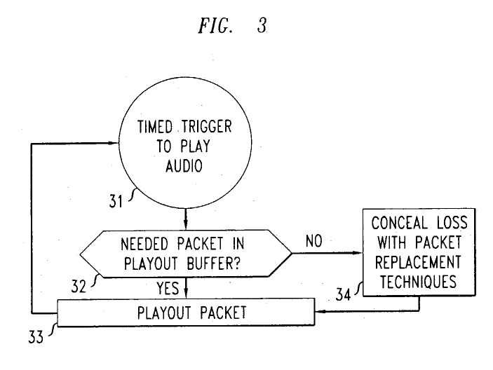

FIG. 2 shows a flow chart of an illustrative input buffer management process in accordance with the illustrative embodiment of FIG. 1. In particular, the flow chart of FIG. 2 describes a process which illustratively executes (i.e., its execution is triggered) upon receipt of each packet.

As is shown in the figure, the process begins its iteration by receiving a (new) packet (in block 21) and placing the packet in the input buffer in its appropriate place in the packet sequence (block 22). If, as determined by decision box 23, the decoder does not need to process the packets in order (i.e., sequentially), the received packet is immediately sent to the decoder for decoding (block 24). If, however, the decoder requires that it process the packets in sequential order, decision box 25 determines if the “next” sequential packet (with reference to the last packet sent to the decoder) is, in fact, available in the input buffer. If it is, the packet is sent to the decoder for decoding (block 26). Otherwise, control returns to block 21 to wait for the receipt of another packet.

FIG. 3 shows a flow chart of an illustrative playout buffer management process in accordance with the illustrative embodiment of FIG. 1. In particular, the flow chart of FIG. 3 describes a process which illustratively executes (i.e., its execution is triggered) when the next signal segment (for example, an audio segment) needs to be played out from the playout buffer, typically according to some predetermined regular time interval.

As is shown in the figure, the process begins when triggered by the timed trigger to play out a signal (illustratively, audio) segment of the reconstructed signal (block 31). Then, decision box 32 determines whether the needed packet (i.e., the next sequential packet with reference to the last packet played out) is present in the playout buffer. If it is, the decoded frames of the given packet are played out (block 33). If, however, it is not available, a packet replacement technique in accordance with one of the illustrative embodiments of the present invention is employed (in block 34) to conceal the loss. (That is, the missing packet is replaced with a packet synthesized in accordance with the principles of the present invention.)

In accordance with one illustrative embodiment of the present invention, the illustrative packet replacement method described herein may be advantageously implemented as a pair of subroutines that operate as independent threads. The following pseudocode describes each of two such subroutines as applied in particular to a coded (and transmitted) audio signal.

Specifically, the “Receive Buffer” routine and the “Playout” routine shown below illustratively operate as different threads in a producer-consumer relationship. This is appropriate since both are triggered by separate, external events. In particular, the Receive Buffer subroutine produces the playout buffer (i.e., it fills it), and the Playout subroutine consumes it (i.e., plays it out and then clears it).

The following is the “Receive Buffer” subroutine pseudocode. More specifically, this function places the packets in their correct order when they arrive from the network. It the packet received can be decoded, it is decoded immediately. Note that since decoding can take a variable amount of time, decoding “up front” advantageously reduces the risk that the audio will be interrupted because the packet takes too long to decode.

```
Receive Buffer:
  while (CallInProgress)
  {
    ReceivedPacket = WaitforReceivePacketFromNetwork
    (InComingPacketBuffer);
    ReceiveBuffer = PutPacketInDecodeBufferInCorrectOrder
    ReceivedPacket);
    if (CodecRequiresDecodesHappenInOrder (CodecTypeForThisCall))
    {
      while ( NextPacketToDecodeIsAvailable (ReceiveBuffer))
      {
          PCMBuffer = DecodePacketIntoPCM (ReceiveBuffer,
                      PacketFoundFlag);
      }
      {
      else
      {
          PCMBuffer = DecodePacketIntoPCM (ReceiveBuffer,
                      PacketFoundFlag);
      }
  }
```

The following is the “Playout” subroutine pseudocode. This function waits until a packet is ready to be played. At that point, if the packet is available, it is played. If no packet is available however, packet loss concealment is performed based upon previously played material, in accordance with the illustrative embodiment of the present invention. Note that this routine advantageously has at most a single interaction with the decoder. If, for example, the decoder is state dependent and needs to know that a packet loss decision has been made, the codec may be so informed, but any resulting output from the decoder is advantageously ignored. (This is merely to “tip off” to the codec that packet loss concealment will be used, and that no packet will be received.)

```
Playout:
  while (CallInProgress)
  {
    WaitUntilTimeToPlayNextPacket ( );
    /* Packet was found. */
    if (NextExpectedPacketIsAvailable (PCMBuffer))
    {
      PlayoutPointer = SetPointerToNextPacketToPlay (PCMBuffer);
    }
    /* The decision has to be made that the packet is lost. */
    else
    {
      PlayoutPointer = PCMBasedPacketLossConcealment
      (PlayoutBuffer);
      if(CodecRequiresStateUpdateForLoss (CodecTypeForThisCall))
      {
        IgnoredBuffer = DecodePacketIntoPCM (NULL,
                      PacketLostFlag);
      }
    }
    PlayNextAudioPacket (PlayoutPointer);
    }
```

Addendum to the Detailed Description

It should be noted that all of the preceding discussion merely iIllustrates the general principles of the invention. It will be appreciated that those skilled in the art will be able to devise various other arrangements, which, although not explicitly described or shown herein, embody the principles of the invention, and are included within its spirit and scope.

Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

The functions of the various elements shown in the figures, including functional blocks labeled as “processors” or “modules” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

We claim:

1. A method of constructing a reconstruction of a media signal, the media signal having been encoded and transmitted through a packet-based communication system as a sequence of packets, each packet comprising an encoding of one or more frames of said media signal, one or more of said transmitted packets having been received for decoding by a decoder, the method comprising the steps of:
receiving one or more decoded frames from said decoder, the decoded frames resulting from said decoding of said one or more of said received packets;
receiving an indication that one or more of said transmitted packets has not been received and decoded by said decoder;
synthesizing, in response to said indication that said one or more of said transmitted packets have not been received and decoded by said decoder, one or more frames of said media signal based on said one or more decoded frames, said synthesized frames corresponding to said one or more of said transmitted packets that have not been received and decoded by said decoder; and
constructing said reconstruction of said media signal based on said one or more decoded frames and on said one or more synthesized frames.

2. The method of claim 1 wherein the media signal comprises a speech signal.

3. The method of claim 1 wherein the media signal comprises an audio signal.

4. The method of claim 1 wherein the media signal comprises a video signal.

5. The method of claim 1 wherein said step of synthesizing said one or more frames of said media signal based on said one or more decoded frames comprises repeating a previous set of one or more frames of said reconstruction of said media signal.

6. The method of claim 1 wherein said step of synthesizing said one or more frames of said media signal based on said one or more decoded frames comprises using a previous set of one or more frames of said reconstruction of said media signal, and attenuating one or more gain values thereof.

7. The method of claim 1 wherein said step of synthesizing said one or more frames of said media signal based on said one or more decoded frames comprises using a previous set of one or more frames of said reconstruction of said media signal, and performing boundary smoothing between said previous set of one or more frames and said one or more frames to be synthesized.

8. The method of claim 1 wherein said step of synthesizing said one or more frames of said media signal based on said one or more decoded frames comprises using a previous set of one or more frames of said reconstruction of said media signal, and performing boundary smoothing between said one or more frames to be synthesized and a subsequent set of one or more frames.

9. The method of claim 1 further comprising the steps of
determining that one or more of said transmitted packets has not been received, and
providing said indication that said one or more of said transmitted packets has not been received and decoded by said decoder based thereupon.

10. The method of claim 9 further comprising the step of decoding said one or more of said received packets.

11. An apparatus for constructing a reconstruction of a media signal, the media signal having been encoded and transmitter through a packet-based communication system as a sequence of packets, each packet comprising an encoding of one or more frames of said media signal, one or more of said transmitted packets having been received for decoding by a decoder, the apparatus comprising:
means for receiving one or more decoded frames from said decoder, the decoded frames resulting from said decoding of said one or more of said received packets;
means for receiving an indication that one or more of said transmitted packets has not been received and decoded by said decoder;
a signal synthesizer which, in response to said indication that said one or more of said transmitted packets have not been received and decoded by said decoder, synthesizes one or more frames of said media signal based on said one or more decoded frames, said synthesized frames corresponding to said one or more of said transmitted packets that have not been received and decoded by said decoder; and
means for constructing said reconstruction of said media signal based on said one or more decoded frames and on said one or more synthesized frames.

12. The apparatus of claim 11 wherein the media signal comprises a speech signal.

13. The apparatus of claim 11 wherein the media signal comprises an audio signal.

14. The apparatus of claim 11 wherein the media signal comprises a video signal.

15. The apparatus of claim 11 wherein said signal synthesizer synthesizes said one or more frames of said media signal by repeating a previous set of one or more frames of said reconstruction of said media signal.

16. The apparatus of claim 11 wherein said signal synthesizer synthesizes said one or more frames of said media signal by using a previous set of one or more frames of said reconstruction of said media signal, and by attenuating one or more gain values thereof.

17. The apparatus of claim 11 wherein said signal synthesizer synthesizes said one or more frames of said media signal by using a previous set of one or more frames of said reconstruction of said media signal, and by performing boundary smoothing between said previous set of one or more frames and said one or more frames to be synthesized.

18. The apparatus of claim 11 wherein said signal synthesizer synthesizes said one or more frames of said media signal by using a previous set of one or more frames of said reconstruction of said media signal, and by performing boundary smoothing between said one or more frames to be synthesized and a subsequent set of one or more frames.

19. The apparatus of claim 1 further comprising
means for determining that one or more of said transmitted packets has not been received, and
means for providing said indication that said one or more of said transmitted packets has not been received and decoded by said decoder based thereupon.

20. The apparatus of claim 19 further comprising a decoder which decodes said one or more of said received packets.
